(19) United States
(12) Patent Application Publication
(10) Pub. No.: US 2009/0087574 A1
(43) Pub. Date: Apr. 2, 2009

(54) PHYSICAL PROTECTION SYSTEM FOR AN AIR SUPPORTED STRUCTURE

(76) Inventor: Gregory C. Burdick, St. Charles, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/863,806

(22) Filed: Sep. 28, 2007

(51) Int. Cl. B05D 1/02

(52) U.S. Cl. 427/427.4

(57) ABSTRACT

A coating process for protecting the fabric from which sidewall and roof sections of an air supported structure (S) are made. The coating is a plurality of commercially available urethane coatings which is sprayed onto the outer surface of the fabric after the surface has been prepared by high-pressure spraying. The coating is an elastomeric urethane coating that is fire resistant, protects against corrosion, impact and abrasion. The coating is a permanent coating which, after curing, cannot be removed, but can be painted over. The coating can also be washed, with an appropriate cleanser, to remove paint or other materials used to draw graffiti on the material. The coating helps prolong the service life of the structure, particularly in harsh or demanding environments such as are found in the desert (high temperatures, high winds, blowing sand) and at higher latitudes (extreme cold, high winds, blowing sleet and damaging hail).

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates to air supported or inflatable structures, and more particularly to a system for applying a fire resistant coating to the exterior of a new or existing air supported structure so to provide environmental protection to the fabric with which the structure is constructed, as well as protection from vandalism such graffiti painted on drawn on a surface of the fabric. Certain formulations of the coatings used for this purpose also provide bomb blast and fragmentation protection.

Air supported structures comprise an inflatable fabric material which is attached to a foundation or footing that extends around the perimeter of the structure. When air is introduced beneath the fabric, it extends, or forces, the fabric gradually upward to form a roof and sidewall for the structure. This roof remains in place so long as a sufficient air pressure is maintained on the underside of the fabric. The foundation over which the roof is raised typically comprises a concrete slab having a series of anchors spaced around the perimeter of the slab. Interconnected sections of the material are attached to the anchors to hold the sections in place when the fabric expands to raise the structure, and to keep the sections in place once the building is erected.

With the current form of construction, the structure is subject to damage from environmental conditions including high winds, sleet, hail, etc. The fabric can be rent or torn, or wear away (corrode) over time due to the persistent blowing of sand, dirt, rocks, and grit against the material. Such damage to the structure can result in its collapse, or the need to repair or replace sections of the fabric. This often necessitates collapsing the structure while repairs are affected which, in turn, means that whatever activities take place inside the building have to be suspended for the duration of the repairs. A sudden collapse of the building may result in injury to the people inside it at the time, as well as the damage or destruction of equipment within housed within structure.

It is also commonplace for vandals to deface the structure by writing graffiti on the outer surface of the fabric, or to slice into it with a knife or the like. Again this can necessitate costly repairs and lost usage of the structure.

The present invention is directed to the application of a sprayed-on elastomeric urethane coating that is fire resistant, protects against corrosion, impact and abrasion of the fabric, and also allows graffiti left by vandals to be easily removed.

### BRIEF SUMMARY OF THE INVENTION

The present disclosure is directed to a coating process for protecting the fabric from which sidewall and roof sections of an air supported structure are made. The coating comprises one of a plurality of commercially available urethane coatings which is sprayed onto the outer surface of the fabric after the fabric has been prepared. The coating is an elastomeric urethane coating that is fire resistant, protects against corrosion, impact and abrasion. The coating is a permanent coating which, after curing, cannot be removed, but can be painted over. It can also be washed with an appropriate cleanser to readily remove paint or other materials used to draw graffiti on the fabric sections.

The coating is particularly useful for prolonging the service life of the structure particularly in harsh or demanding environments such as are found in the desert (high temperatures, high winds, blowing sand) and at higher latitudes (extreme cold, high winds, blowing sleet and damaging hail). In the latter environments, the coating increases the insulation factor (R value) of the building. Wherever the building is erected, the coating covers rents or holes in the fabric so to reduce the air loss which is a continual problem with air supported structures.

If the coating is damaged, it can be patched, in place, so that the structure does not have to be lowered. This substantially reduces or eliminates “down time” of the facility and makes it continuously available to those using it. The outside of the fabric can be washed down with a variety of chemical solutions without harming the coating or reducing its useful life. Also, the coating remains flexible through temperatures ranging from −40° F. to +320° F. (−40° C. to +160° C.). This flexibility is especially important in an air supported structure since a natural aspect of these types of structures is that they flex while adjusting to differences between internal and external pressures.

Finally, in addition to environmental protection and protection against vandalism, blast and fragmentation protection is also provided by application of the coating.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a plan view of an air supported structure; and,

FIG. 2 is an elevation view thereof.

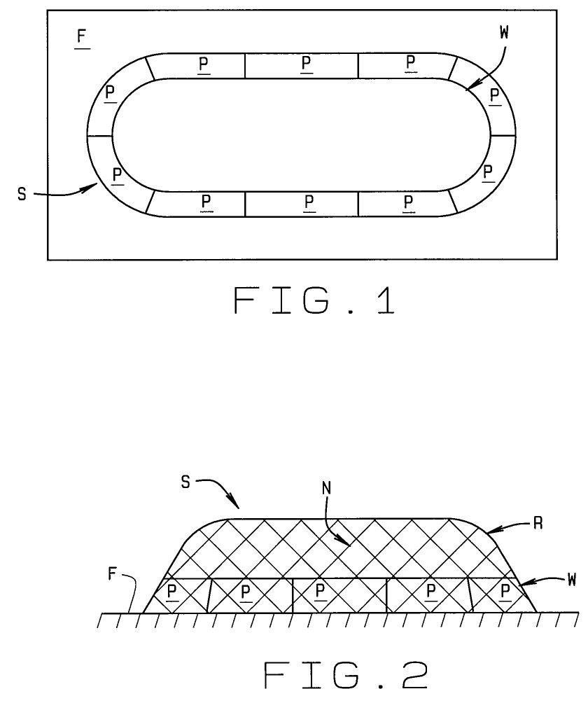

Corresponding reference characters indicate corresponding parts in the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, an air supported structure is indicated generally S. Structure S is typically erected on a foundation F and includes a plurality of interconnected panels P which, when air is pumped under them, rise above the foundation and form a roof R and sidewalls W of the structure. The size and shape of the panels and they manner in which they are interconnected with each other to form the roof and sidewall of the structure form no part of this invention.

As discussed previously, air supported structures S are often erected in areas where extreme weather conditions often prevail. As a consequence, the roof and sidewall panels are continuously subjected to very hot or very cold temperatures, high winds, blowing dust, dirt, or sand, or blowing rain, sleet, or hail. Over time, pinholes, tears, etc. are created in the fabric material from which the panels are made. These results in air leaks which, in the short term, require more air to be continuously pumped into the building to keep it inflated. In the long term, it usually means collapsing the building and replacing the panels.

The present invention is directed to an elastomeric urethane coating and method for applying the coating to one side, or both sides, of the panels, so to protect the panel fabric from damage thereby prolonging the life of the panels and reducing the cost of maintaining the structure. With respect to the coating, a preferred coating for use in the process is identified as formulation XS-152™ which is manufactured by Line-X, an industrial coatings manufacturer. Urethane coating with formulations similar to that of XS-152™ and produced by other manufacturers are also acceptable for use in accordance with the invention.

There are two primary methods of applying the urethane coating to the fabric material of the panels. The first method is referred to as a modular process; while the second comprises application of the coating in-situ, that is, at the location of an existing or newly installed air supported structure.

The modular process involves first affixing a panel of the material in a horizontal or upright, vertical position to a frame (not shown). The surface of the panel is then subjected to a high pressure water spray to insure it is clean. After the surface has dried, the urethane coating is sprayed onto the surface. After it is applied, the thickness of the coating should range between 0.0625″-0.50″ (0.16 cm-1.27 cm). Once the coating has dried, it is removed from the frame and shipped to the location where structure S is being erected. At that location, the coated panels are heat welded together to form the roof and sidewall of the structure. The structure is then erected as is well-known in the art. If the coated panels are being used to replace existing panels, the structure is collapsed and a cable net N (see FIG. 2) covering structure S is removed. The panel being replaced is now cut away from the other panels forming the structure, and the replacement panel is heat welded to the remaining external fabric envelope, so to create a protective barrier around the perimeter of the structure at a desired height. The cable net is then reattached to the base of the structure and it is raised.

It will be appreciated by those skilled in the art that the coating of a panel could take place at the location where the structure is erected. One reason for not doing so is that air supported structures, as noted, are often erected in areas of adverse climates. While the panel does not require a primer or other precoating prior to application of the urethane coating, application of the coating is preferably done when the temperature is in the range of +40° F. and +55° F. (+4° C. and +13° C.). Accordingly, if a panel is coated with the urethane coating in a cold climate, a tent or other covering is erected about the frame on which the panel is mounted, and heaters are used to elevate the temperature within the tent into the acceptable coating range.

Regardless of where the coating is applied, the typical cure time of the coating is approximately 10 sec, with load bearing cure time being approximately 24 hrs. As to the effect of the environment on the coating, it has been found that extremely cold temperatures; i.e., temperatures below −40° F. (−40° C.) will not cause the coating to fail but will decrease its flexibility.

Besides coating individual panels, an entire existing, or newly fabricated structure S can be coated in place where the structure is being erected. As with an individual panel, the coating process begins by pressure washing the exterior of the structure to ensure a clean surface to which the urethane coating can properly adhere. Next, the cable net assembly N is removed from a portion of the structure, and doors, windows, or any other areas where coating is not necessary or desired is masked. When weather conditions are favorable; i.e., the atmospheric temperature is in the range noted above, the coating is applied. It will be understood that, while the entire unmasked surface of the structure can be coated, in some instances, it is desirable only to coat the surface of the structure to a certain height and/or thickness.

The portion of cable net assembly that had been removed is now reattached into place, the portion of the assembly for the next section of the structure is removed, and the process is repeated. The above described steps are repeated, and the process continues, for each section of structure S until the entire structure is coated.

As described, the coating and coating process of the invention provide a number of advantages. For one, the superior abrasion resistance provided by application of the coating helps ensure the longevity of the air supported structure in demanding environments such as an cold climes, desert locations where extreme abrasions from sand storms otherwise shorten the life expectancy of the fabric used to form the air supported structures sidewall and roof, and ocean front locations where salt, and blowing sand also tend to shorten the life of the fabric.

A second advantage is that even if the coating is damaged, it can be readily repaired by reapplying the coating to the affected area. The building does not have to be collapsed and a panel replaced.

Another advantage is that in cold climates, the coating increases the insulation factor (R value) of the building. In all environments, the coating covers pinholes or other punctures that may have formed in a panel. This significantly reduces the amount of air loss from the structure, and consequently the amount of air having to be pumped into the structure to keep it inflated. Those skilled in the art will understand that the amount of air loss is a continual problem with air supported structures.

Application of the coating does not prevent the surface of the structure from being painted. Painting over the coating, after it has cured, does not affect the properties of the coating. As a practical matter, one usually selects the paint and the paint color prior to application of the coating.

Successive collapses and raisings of the structure do not affect the properties of the coating. In fact, the coating has a useful life which is typically longer than that of structure.

Finally, in certain areas such as war zones, or where terrorists are active, the air supported structure can be coated with a urethane coating that provides blast and fragment protection. One such coating useful in this regard is commercially available from Line-X, under the brand name PAXCON™; although urethane coatings with formulations similar to that of PAXCON™ and produced by other manufacturers are also acceptable for use in accordance with the invention. Application of these coatings is done using the same processes as described above. In addition to the blast protection afforded by these coatings, they also provide advantages obtained using the urethane coatings previously discussed.

In view of the above, it will be seen that the several objects and advantages of the present disclosure have been achieved and other advantageous results have been obtained.

Having thus described the invention, what is claimed and desired to be secured by Letters Patent is:

1. A method for protecting an air supported structure from damage caused by high winds, sand, dirt, and other debris, and rain, sleet and hail, comprising:
mounting a panel forming a section of a roof or sidewall of the structure on a frame;
preparing at least one surface of the panel to be coated with a urethane coating material to a prescribed thickness of material;
spraying the urethane coating onto the previously prepared surface; and,
allowing the coating to cure before installing the panel in place on the structure.

2. The method of claim 1 wherein the temperature at which the coating is applied to the panel is between +40° F. and +55° F. (+4° C. and +13° C.).

3. The method of claim 2 in which the curing time for the coating is approximately 10 sec, with a load bearing cure time of approximately 24 hrs.

4. The method of claim 1 in which the coating is a Line-X XS-152™ urethane coating material, or an equivalent thereof.

5. The method of claim 1 in which the coating is a Line-X PAXCON™ urethane coating material, or an equivalent thereof.

6. The method of claim 1 further including painting the surface of the panel after the coating applied to the surface of the panel has cured.

7. The method of claim 3 in which, if the coating is damaged, it is repaired by reapplying the urethane coating to the damaged area.

8. The process of claim 1 in which applying the coating to a surface of the panel increases the insulation factor (R value) for that portion of the structure.

9. The method of claim 8 in which the coating covers pinholes or other punctures in the panel thereby reducing the amount of air loss from the structure and the amount of air having to be pumped into the structure to keep the structure inflated.

10. A method for protecting an air supported structure from damage caused by high winds, sand, dirt, and other debris, and rain, sleet and hail, comprising:
exposing a section of a roof or sidewall of the structure by removing a portion of a cable net assembly installed over the structure to keep the roof and sidewall in place;
preparing the exposed section to be coated with a urethane coating material to a prescribed thickness of material;
spraying the urethane coating onto the exposed section and allowing the coating to cure; and,
reinstalling the cable net assembly over the exposed section, whereby the coating is applied without having to first collapse the structure.

11. The method of claim 10 further including:
sequentially exposing sections of the roof or sidewall by removing the portion of the cable net assembly installed over the respective sections;
spraying the urethane coating onto each exposed section and allowing the coating to cure; and,
reinstalling the cable net assembly over the exposed section, the above steps being repeated until a desired portion of the roof or sidewall is coated.

12. The method of claim 11 wherein the temperature at which the coating is applied to the panel is between +40° F. and +55° F. (+4° C. and +13° C.).

13. The method of claim 12 in which the curing time for the coating is approximately 10 sec, with a load bearing cure time of approximately 24 hrs.

14. The method of claim 11 in which the coating is a Line-X XS-152™ urethane coating material, or an equivalent thereof.

15. The method of claim 11 in which the coating is a Line-X PAXCON™ urethane coating material, or an equivalent thereof.

16. The method of claim 11 further including painting the surface of the exposed section after the coating applied to the surface of the exposed section has cured.

17. The method of claim 12 in which, if the coating is damaged, it is repaired by reapplying the urethane coating to the damaged area.

18. The process of claim 11 in which applying the coating to a surface of the exposed section increases the insulation factor (R value) for that portion of the structure.

19. The method of claim 18 in which the coating covers pinholes or other punctures in the panel thereby reducing the amount of air loss from the structure and the amount of air having to be pumped into the structure to keep the structure inflated.
